(19) United States
(12) Patent Application Publication
(10) Pub. No.: US 2011/0102364 A1
(43) Pub. Date: May 5, 2011

(54) CAPACITIVE TOUCH PANEL

(75) Inventors: Sheng-Hsien Lin, Taoyuan County (TW); Wei-Wen Wang, Taoyuan County (TW); Ting-Chieh Chen, Taoyuan County (TW); Teo Boon Hock, Taoyuan County (TW); Yuh-Rur Kuo, Taoyuan County (TW); Shih-Hsien Ma, Taoyuan County (TW)

(73) Assignee: Transtouch Technology, Inc., Taoyuan County (TW)

(21) Appl. No.: 12/759,040

(22) Filed: Apr. 13, 2010

(30) Foreign Application Priority Data
Nov. 5, 2009 (TW) 098220511

(51) Int. Cl. G06F 3/045

(52) U.S. Cl. 345/174

(57) ABSTRACT

A capacitive touch panel is provided. The capacitive touch panel includes a transparent substrate, a plurality of first sensing wires, a plurality of second sensing units, an insulation layer, a plurality of second sensing wires and a plurality of fourth sensing units. The transparent substrate has a substrate surface on which the insulation layer is disposed. The insulation layer covers the first sensing wires and the second sensing wires. A plurality of third sensing units of the second sensing wires is disposed on the insulation layer along a second axial direction. The fourth sensing units are disposed on the insulation layer along a first axial direction. The third sensing units and the fourth sensing units are adjacently arranged.

This application claims the benefit of Taiwan application Serial No. 98220511, filed Nov. 5, 2009, the subject matter of which is incorporated herein by reference.

### BACKGROUND OF THE INVENTION

1. Field of the Invention

The invention relates in general to a capacitive touch panel, and more particularly to a capacitive touch panel with via holes.

2. Description of the Related Art

Referring to FIG. 1 (prior art), a schematic diagram of a generally known capacitive touch panel is shown. The capacitive touch panel 100 includes a substrate 102, a plurality of X-axial sensing wires 104, a plurality of Y-axial sensing wires 106 and an insulation layer 108.

The X-axial sensing wires 104 are disposed on the substrate 102. The insulation layer 108 covers the X-axial sensing wires 104 and separates the X-axial sensing wires 104 from the Y-axial sensing wires 106.

However, the X-axial sensing wires 104 and the Y-axial sensing wires 106 are generally disposed on two different planes, and have poor performance in the transmission of the light due to an insulation layer 108 being interposed between the X-axial sensing wires 104 and the Y-axial sensing wires 106. Thus, the capacitive touch panel 100 is subjected to the problem of color cast.

The adjacent Y-axial sensing wires 106 are spaced by a first distance D1, and are obvious on the appearance of the capacitive touch panel 100. For example, if the Y-axial sensing wires 106 are yellow, there will be yellow traces visible on the appearance of the capacitive touch panel 100, not only spoiling the aesthetics but also affecting the display quality of the capacitive touch panel 100.

### SUMMARY OF THE INVENTION

The invention is directed to a capacitive touch panel. The sensing units on the same plane are adjacently disposed, so that the clearance between the sensing units is reduced, not only enhancing the color uniformity on the panel surface of the capacitive touch panel but also improving the display quality of the capacitive touch panel.

According to a first aspect of the present invention, a capacitive touch panel is provided. The capacitive touch panel includes a transparent substrate, a plurality of first sensing wires, a plurality of second sensing units, an insulation layer, a plurality of second sensing wires and a plurality of fourth sensing units. The transparent substrate has a substrate surface. The first sensing wires are disposed on the substrate surface along a first axial direction, wherein each first sensing wire includes a plurality of first sensing units. The second sensing units are disposed on the substrate surface along a second axial direction. The insulation layer is disposed on the substrate surface, covers the first sensing wires and the second sensing units, and has a plurality of via holes. Each second sensing wire is disposed on the insulation layer along the second axial direction, and includes a plurality of third sensing units. The fourth sensing units are disposed on the insulation layer along the first axial direction. Wherein, the first sensing units are corresponding to the fourth sensing units, the second sensing units are corresponding to the third sensing units, corresponding the first sensing unit and the fourth sensing unit are electrically connected through one of the via holes, and corresponding the second sensing unit and the third sensing unit are electrically connected through another of the via holes.

According to a second aspect of the present invention, a capacitive touch panel is provided. The capacitive touch panel includes a transparent substrate, an insulation layer, a plurality of conductive wires, a plurality of sensing wires and a plurality of sensing units. The transparent substrate has a substrate surface on which the insulation layer is disposed, wherein the insulation layer has a plurality of via holes. The conductive wires are disposed on one of the substrate surface and the insulation layer along a first axial direction. A plurality of sensing wires is disposed on the other of the substrate surface and the insulation layer along a second axial direction. The sensing units are separately disposed on the other of the substrate surface and the insulation layer along the first axial direction. Wherein, each conductive wire is electrically connected to the corresponding sensing units through via holes.

The invention will become apparent from the following detailed description of the preferred but non-limiting embodiments. The following description is made with reference to the accompanying drawings.

### BRIEF DESCRIPTION OF THE DRAWINGS

FIG. 1 (prior art) shows a schematic diagram of a generally known capacitive touch panel;

FIG. 2 shows a schematic diagram of a capacitive touch panel according to a preferred embodiment of the invention;

FIG. 3 shows a schematic diagram of the first sensing units and the second sensing units of FIG. 2 viewed in the direction V1;

FIG. 4 shows a schematic diagram of the third sensing units and the fourth sensing units of FIG. 2 viewed in the direction V1;

FIG. 5 shows a schematic diagram of the size of the first sensing units and the fourth sensing units of FIG. 2;

FIG. 6 shows a schematic diagram of a capacitive touch panel with an optical film according to an embodiment of the invention;

FIG. 7 shows a schematic diagram of a capacitive touch panel according to the second embodiment of the invention;

FIG. 8 shows a cross-sectional view along the direction 8-8′ of FIG. 7;

FIG. 9 (only shows the conductive wires) shows a partial enlargement of the portion A of FIG. 7;

FIG. 10 shows a schematic diagram of conductive wires according to another implementation of the invention;

FIG. 11 shows a schematic diagram of conductive wires according to yet another implementation of the invention;

FIG. 12 shows a schematic diagram of conductive wires according to other implementations of the invention;

FIG. 13 shows a schematic diagram of a capacitive touch panel according to the third embodiment of the invention; and

FIG. 14 shows a cross-sectional view along the direction 14-14′of FIG. 13.

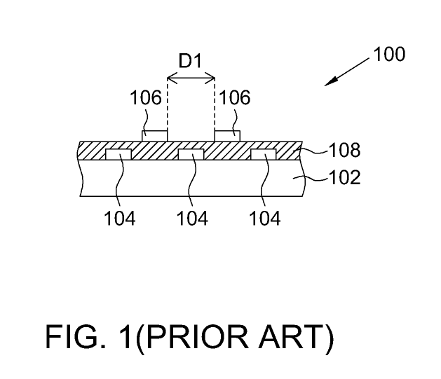

### DETAILED DESCRIPTION OF THE INVENTION

A number of preferred embodiments are disclosed below for elaborating the details of the invention. However, the invention is not limited to the embodiments, and the drawings and disclosure are for detailed description of the invention not for limiting the scope of protection of the invention. Moreover, secondary elements are omitted in the embodiments to highlight the characteristics of the invention.

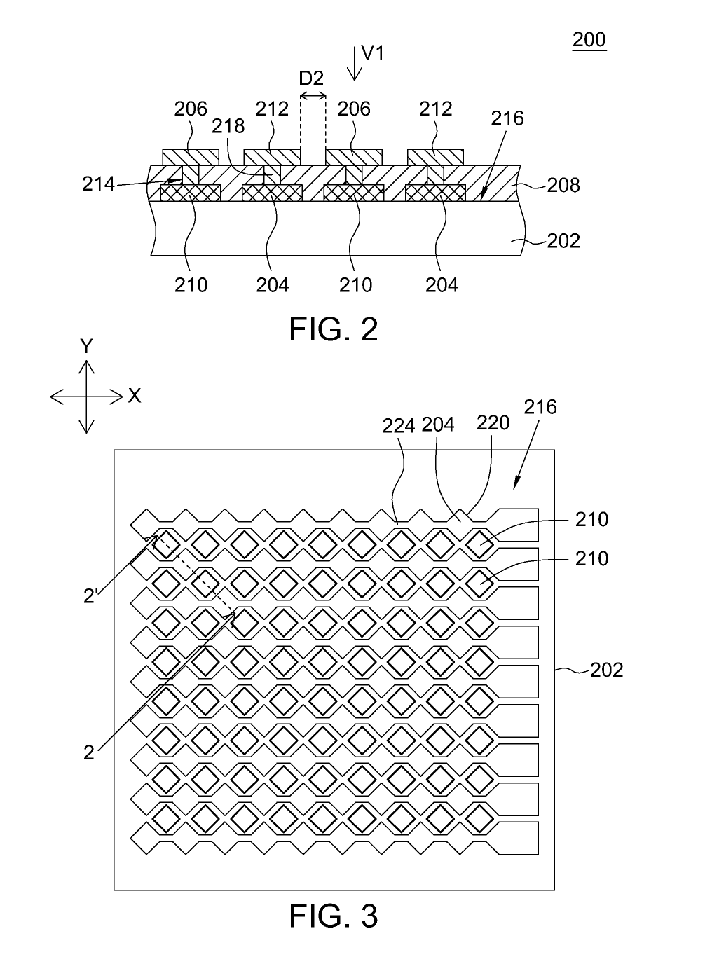

Referring to FIG. 2, a schematic diagram of a capacitive touch panel according to a preferred embodiment of the invention is shown. The capacitive touch panel 200 includes a transparent substrate 202, a plurality of first sensing units 204, a plurality of second sensing units 210, an insulation layer 208, a plurality of third sensing units 206 and a plurality of fourth sensing units 212.

The transparent substrate 202 has a substrate surface 216 on which the first sensing units 204 and the second sensing units 210 are disposed. The transparent substrate 202 could be made from an insulation material with high light transmission such as glass, polycarbonate (PC), polyethylene terephthalate, (PET), polymethylmethacrylate (PMMA) or cyclic olefin copolymer.

The insulation layer 208 is disposed on the substrate surface 216, covers the first sensing units 204 and the second sensing units 210, includes a plurality of conductive elements 218, and has a plurality of via holes 214 in which the conductive elements 218 correspondingly are disposed.

The first sensing units 204 are corresponding to the fourth sensing units 212, and the second sensing units 210 are corresponding to the third sensing units 206. That is, the positions of the first sensing units 204 and the positions of the fourth sensing units 212 are overlapped, and the positions of the second sensing units 210 and the positions of the third sensing units 206 are overlapped. Corresponding the first sensing unit 204 and the fourth sensing unit 212 are electrically connected through one via holes 214, and corresponding the second sensing unit 210 and the third sensing unit 206 are also electrically connected through another of via holes 214.

Corresponding the first sensing unit 204 and the fourth sensing unit 212 could improve the sensitivity of the capacitive touch panel 200, and corresponding the second sensing unit 210 and the third sensing unit 206 achieve the same effect.

Through the arrangement of disposing the third sensing units 206 between two adjacent fourth sensing units 212, the second distance D2 between the adjacent sensing units is smaller than the first distance D1 as in the prior art. Thus, the traces will not be seen on the appearance of the capacitive touch panel 200, and the display quality of the capacitive touch panel 200 is improved. For example, the transmission of the light of the capacitive touch panel 200 is more uniform.

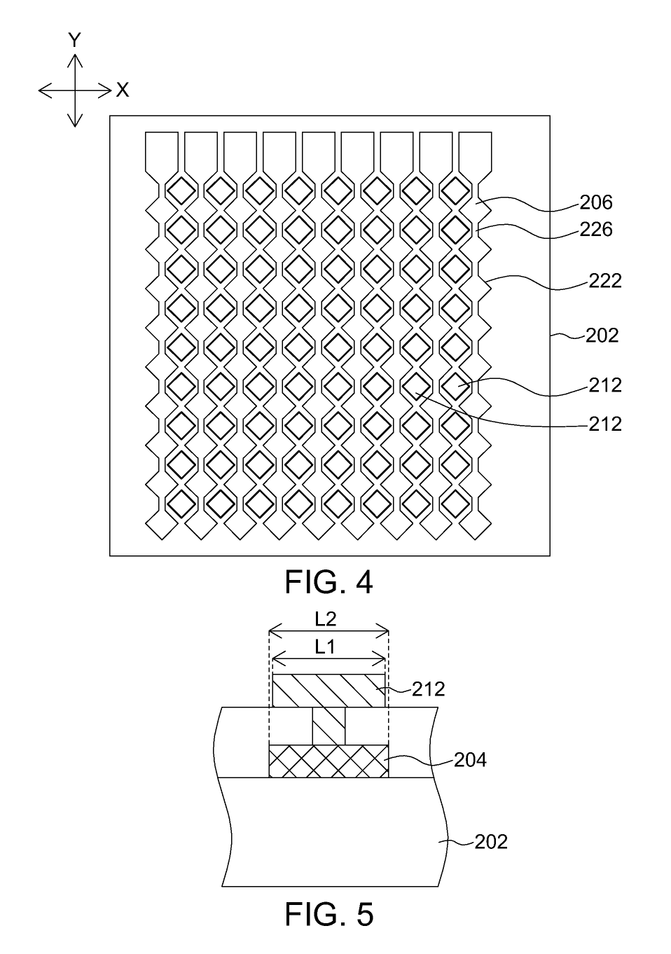

Referring to FIG. 3 and FIG. 4. FIG. 3 shows a schematic diagram of the first sensing units and the second sensing units of FIG. 2 viewed in the direction V1. FIG. 4 shows a schematic diagram of the third sensing units and the fourth sensing units of FIG. 2 viewed in the direction V1. Wherein, FIG. 2 is a cross-sectional view along the direction 2-2′ of FIG. 3.

In order to more clearly illustrate the first sensing units 204 and the second sensing units 210, the insulation layer 208, the third sensing units 206 and the fourth sensing units 212 are not illustrated in FIG. 3. In order to more clearly illustrate the third sensing units 206 and the fourth sensing units 212, the insulation layer 208, the first sensing units 204 and the second sensing units 210 are not illustrated in FIG. 4.

As indicated in FIG. 3, each first sensing wire 220 is disposed on the substrate surface 216 along a first axial direction. Each first sensing wire 220 includes the first sensing units 204 and a plurality of connection lines 224. The adjacent two first sensing units 204 are electrically connected through the connection lines 224, so that the first sensing wires 220 in the entire row are electrically connected. The second sensing units 210 in each column are disposed on the substrate surface 216 along a second axial direction. Wherein, the first axial direction is the X-axial sensing direction of the capacitive touch panel 200, and the second axial direction is the Y-axial sensing direction of the capacitive touch panel 200.

As indicated in FIG. 4, each second sensing wire 222 is disposed on the insulation layer 208 along the second axial direction, and the fourth sensing units 212 in each row are disposed on the insulation layer along the first axial direction. Each second sensing wire 222 includes the third sensing units 206 and a plurality of connection lines 226. The adjacent two third sensing units 206 are electrically connected through the connection lines 226, so that the second sensing wires 222 in the entire column are electrically connected. The third sensing units 206 are disposed on the insulation layer 208 (illustrated in FIG. 2) along the second axial direction.

Despite in the present embodiment of the invention, the first axial direction is exemplified by the X-axial sensing direction and the second axial direction is exemplified the Y-axial sensing direction, the invention is not limited thereto. In other implementations, the first axial direction could be exemplified by the Y-axial sensing direction and the second axial direction could be exemplified by the X-axial sensing direction.

The first sensing wires 220 and the second sensing units 210 could be made from indium tin oxide (ITO) or a transparent organic conductive material, such as 3,4-ethylenedioxythiophene (PEDOT). The first sensing wires 220 and the second sensing units 210 could be made from the same material in the same manufacturing process such as the sputtering process.

The second sensing wires 222 and the fourth sensing units 212 could be made from indium tin oxide or a transparent organic conductive material. The second sensing wires 222 and the fourth sensing units 212 could be made from the same material in the same manufacturing process such as the sputtering process.

In an implementation, the third sensing units 206, the fourth sensing units 212 and the conductive elements 218 could be made from the same material. The third sensing units 206, the fourth sensing units 212 and conductive elements 218 could be made from the same material in the same manufacturing process such as the sputtering process.

Besides, the cross-sectional area of the fourth sensing units 212 is smaller than that of the corresponding first sensing units 204. Referring to FIG. 5, a schematic diagram of the size of the first sensing units and the fourth sensing units of FIG. 2 is shown. The width L1 of the fourth sensing units 212 is smaller than the width L2 of the first sensing units 204, so that the fourth sensing units 212 viewed from the top of FIG. 5 is located within the range of the first sensing units 204.

Or, in another implementation, the cross-sectional area of the fourth sensing units 212 is substantially equal to that of the first sensing units 204.

Besides, the relation of the size of the third sensing units 206 and that of the second sensing units 210 is similar to the relation of the size of the fourth sensing units 212 and the first sensing units 204, and the similarities are not repeated here.

Referring to FIG. 6, a schematic diagram of a capacitive touch panel with an optical film according to an embodiment of the invention is shown. The capacitive touch panel 300 further includes an optical film 302, and covers the third sensing units 206 of the second sensing wires 222, of the connection lines 226, and the fourth sensing units 212. The optical film 302 could improve the transmission of the light, and preferably, the refractive index of the optical film 302 is smaller than 1.7. The optical film 302 is made from silicon oxide, magnesium fluoride, aluminum oxide or yttrium oxide, and preferably is made from silicon oxide.

### Second Embodiment

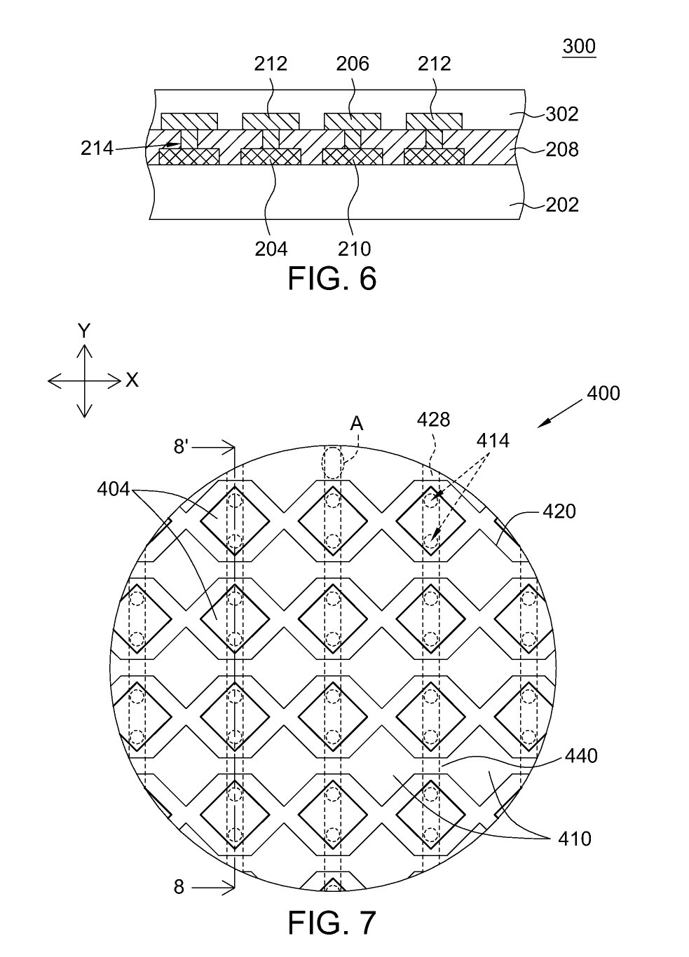

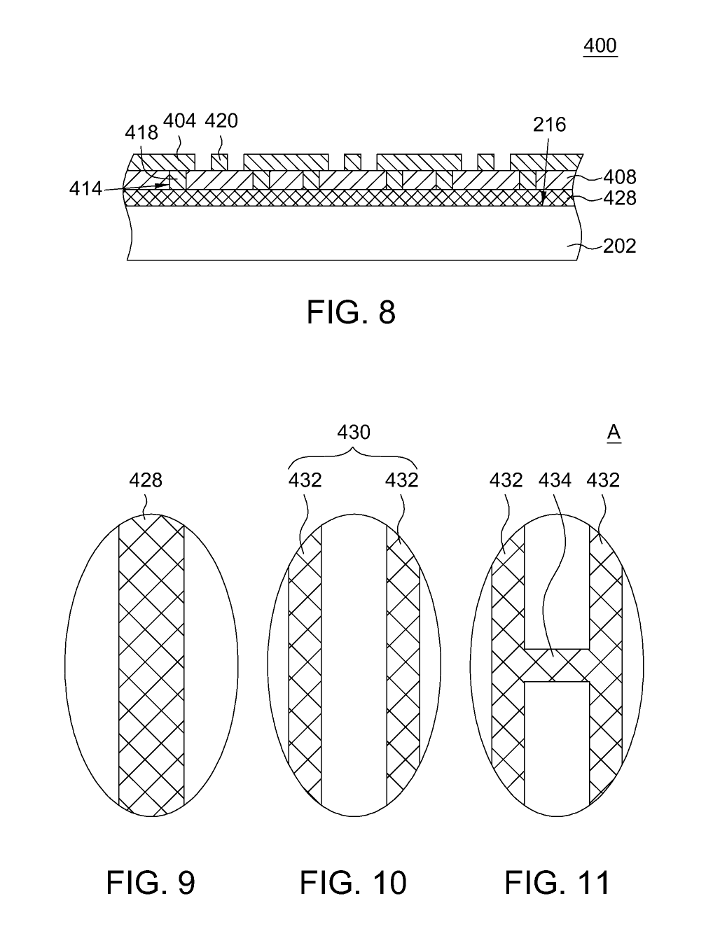

Referring to both FIG. 7 and FIG. 8. FIG. 7 shows a schematic diagram of a capacitive touch panel according to the second embodiment of the invention. FIG. 8 shows a cross-sectional view along the direction 8-8′ of FIG. 7. As for the similarities between the second embodiment and the first embodiment, the same designations are used, and the similarities are not repeated here.

As indicated in FIG. 7, the capacitive touch panel 400 includes a transparent substrate 202, an insulation layer 408 (illustrated in FIG. 8), a plurality of conductive wires 428, a plurality of sensing wires 420 and several columns of sensing units 404, wherein, the conductive wires 428 covered by the insulation layer 408 are denoted by dotted lines.

Each conductive wire 428 and the sensing units 404 in each column are disposed along a first axial direction, wherein the sensing units 404 are separately disposed. Each sensing wire 420 is disposed along a second axial direction, and includes a plurality of sensing units 410 and a plurality of connection lines 440. The adjacent two sensing units 410 are electrically connected through the connection lines 440, so that sensing wires 420 in the entire row are electrically connected.

Despite in the present embodiment of the invention, the first axial direction is exemplified by the Y-axial sensing direction and the second axial direction is exemplified the X-axial sensing direction, the invention is not limited thereto, and in other implementations, the first axial direction could be exemplified by the X-axial sensing direction and the second axial direction could be exemplified by the Y-axial sensing direction.

Through the intensive arrangement of the sensing units 410 of the sensing wires 420 and the sensing units 404 being separately disposed, visible traces will not appear on the capacitive touch panel 400, so that the display quality of the capacitive touch panel 400 is improved. For example, the transmission of the light of the capacitive touch panel 400 becomes more uniform.

As indicated in FIG. 8, the insulation layer 408 is disposed on the substrate surface 216, includes a plurality of conductive elements 418, and has via holes 414. The conductive wires 428 are disposed on the substrate surface 216, and the sensing wires 420 and the sensing units 404 are disposed on the insulation layer 408. The conductive elements 418 correspondingly are disposed in via holes 414 for electrically connecting the corresponding sensing units 404 and the conductive wires 428. Each conductive wire 428 is electrically connected to the corresponding sensing units 404 through the conductive elements 418.

The conductive elements 418, the sensing wires 420 and the sensing units 404 are made from indium tin oxide or a transparent organic conductive material, such as 3,4-ethylenedioxythiophene. The conductive elements 418, the sensing wires 420 and the sensing units 404 could be made from the same material in the same manufacturing process such as the sputtering process.

Referring to FIG. 9 (only shows the conductive wires), a partial enlargement of the portion A of FIG. 7 is shown. In the present embodiment of the invention, the conductive wire 428 is a single wire. However the invention is not limited to the above exemplification. In another implementation as indicated in FIG. 10, a schematic diagram of conductive wires according to another implementation of the invention is shown. Each conductive wire 430 includes two sub-conductive wires 432. The width of the sub-conductive wires 432 is smaller than that of the conductive wire 428, so that the parasitic capacitance between the conductive wires and the sensing units is reduced and the sensing sensitivity is increased.

Or, in another implementation as indicated in FIG. 11, a schematic diagram of conductive wires according to another implementation of the invention is shown. Each conductive wire 430 includes two sub-conductive wires 432 and a cross conductive wire 434 connecting the two sub-conductive wires 432.

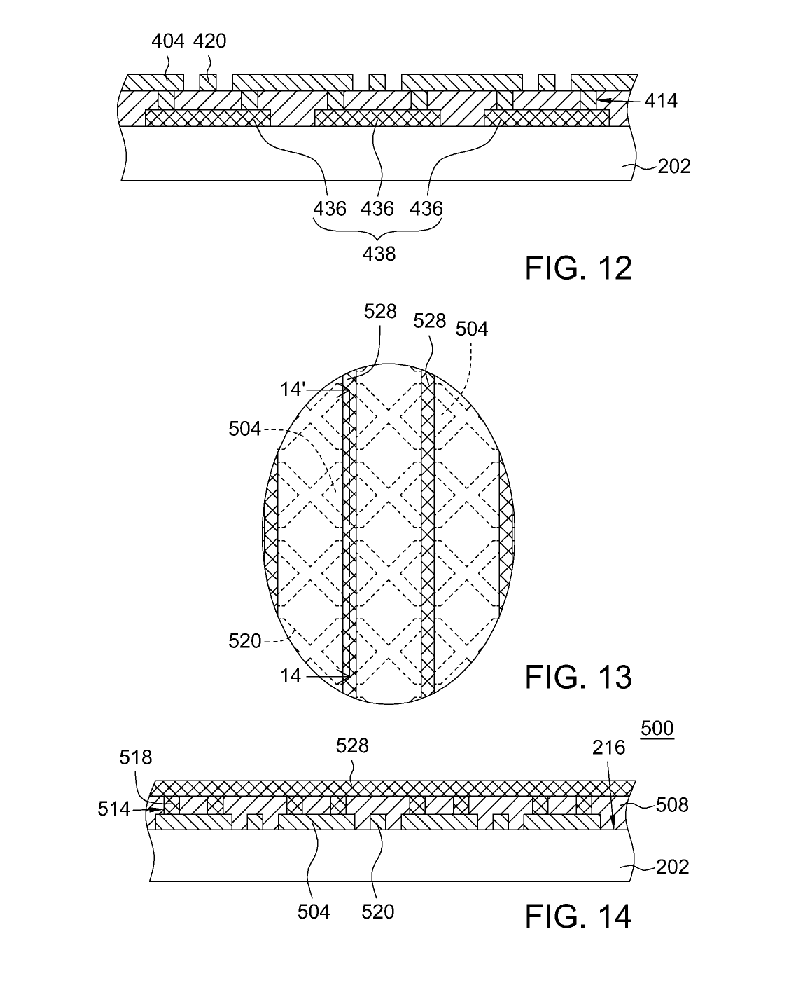

Or, in other implementations as indicated in FIG. 12, a schematic diagram of conductive wires according to other implementations of the invention is shown. To avoid complication in the diagram, only the sensing units 404, via holes 414 and the conductive wires 438 are illustrated in FIG. 12. Each conductive wire 438 includes a plurality of sub-conductive wires 436 being electrically isolated. Every adjacent two of the sensing units 404 are electrically connected to the corresponding sub-conductive wires 436 through via holes 414.

In an embodiment, the capacitive touch panel 400 further includes an optical film (not illustrated) for increasing the transmission of the light. The optical film is similar to that of the optical film 302 of the second embodiment, and the similarities are not repeated here.

### Third Embodiment

Referring to both FIG. 13 and FIG. 14. FIG. 13 shows a schematic diagram of a capacitive touch panel according to the third embodiment of the invention. FIG. 14 shows a cross-sectional view along the direction 14-14′ of FIG. 13. As for the similarities between the third embodiment and the second embodiment, the same designations are used, and the similarities are not repeated here. The capacitive touch panel 500 of the third embodiment is different from the capacitive touch panel 400 of the second embodiment in that the conductive wires 528 of the capacitive touch panel 500 are disposed on the insulation layer 508, and the sensing units 504 and the sensing wires 520 are disposed on the substrate surface 216.

As indicated in FIG. 13, the capacitive touch panel 500 includes a transparent substrate 202, an insulation layer 508 (illustrated in FIG. 14), a plurality of conductive wires 528, a plurality of sensing wires 520 and several rows of sensing units 504, wherein, the sensing wires 520 and the sensing units 504 being covered by the insulation layer 508 are illustrated in dotted lines.

Each conductive wire 528 and each row of the sensing units 504 are disposed along a first axial direction, wherein each sensing unit 504 is separately arranged. Each sensing wire 520 is disposed along a second axial direction. The first axial direction and the second axial direction of the present embodiment of the invention are similar to the first axial direction and the second axial direction of the second embodiment, and the similarities are not repeated here.

As indicated in FIG. 14, the insulation layer 508, is disposed on the substrate surface 216, includes a plurality of conductive elements 518, and has several rows of via holes 514. The conductive wires 528 are disposed on the insulation layer 508, and the sensing wires 520 and the sensing units 504 are disposed on the substrate surface 216. The via hole 514 electrically connect the corresponding sensing units 504 and the conductive wires 528.

The conductive elements 518 and the conductive wires 528 are made from indium tin oxide or a transparent organic conductive material such as 3,4-ethylenedioxythiophene. The conductive elements 518 and the conductive wires 528 could be made from the same material in the same manufacturing process such as the sputtering process.

The structure of the conductive wires 528 is similar to that of the conductive wires 428 of the second embodiment, and the similarities are not repeated here.

In an embodiment, the capacitive touch panel 500 further includes an optical film (not illustrated) for increasing the transmission of the light. The optical film is similar to the optical film 302 of the second embodiment, and the similarities are not repeated here.

According to the capacitive touch panel disclosed in the above embodiments of the invention, the sensing units on the same plane are adjacently disposed, so that the clearance between the sensing units is reduced, not only increasing the color uniformity on the panel surface of the capacitive touch panel but also improving the display quality of the capacitive touch panel.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A capacitive touch panel, comprising:
a transparent substrate having a substrate surface;
a plurality of first sensing wires disposed on the substrate surface along a first axial direction, wherein each of the first sensing wires comprises a plurality of first sensing units;
a plurality of second sensing units disposed on the substrate surface along a second axial direction;
an insulation layer disposed on the substrate surface, wherein the insulation layer covers the first sensing wires and the second sensing units, and has a plurality of via holes;
a plurality of second sensing wires disposed on the insulation layer along the second axial direction, wherein each of the second sensing wires comprises a plurality of third sensing units;
a plurality of fourth sensing units disposed on the insulation layer along the first axial direction;
wherein, the first sensing units are corresponding to the fourth sensing units, the second sensing units are corresponding to the third sensing units, corresponding the first sensing unit and the fourth sensing unit are electrically connected through one of the via holes, and corresponding the second sensing unit and the third sensing unit are electrically connected through another of the via holes.

2. The capacitive touch panel according to claim 1, wherein the first sensing units and the second sensing units are made from the same material.

3. The capacitive touch panel according to claim 1, wherein the third sensing units and the fourth sensing units are made from the same material.

4. The capacitive touch panel according to claim 1, wherein the insulation layer comprises:
a plurality of conductive elements correspondingly disposed in the via holes, wherein the third sensing units, the fourth sensing units and the conductive elements are made from the same material.

5. The capacitive touch panel according to claim 1, wherein the cross-sectional area of each third sensing unit is smaller than or substantially equal to the cross-sectional area of the corresponding second sensing unit.

6. The capacitive touch panel according to claim 1, wherein the cross-sectional area of each fourth sensing unit is smaller than or substantially equal to that of the corresponding first sensing unit.

7. The capacitive touch panel according to claim 1, further comprising:
an optical film disposed on the insulation layer, wherein the optical film covers the second sensing wires and the fourth sensing units.

8. The capacitive touch panel according to claim 7, wherein the refractive index of the optical film is smaller than 1.7.

9. The capacitive touch panel according to claim 8, wherein the optical film is made from silicon oxide, magnesium fluoride, aluminum oxide or yttrium oxide.

10. A capacitive touch panel, comprising:
a transparent substrate having a substrate surface;
an insulation layer disposed on the substrate surface and having a plurality of via holes;
a plurality of conductive wires disposed on one of the substrate surface and the insulation layer along a first axial direction;
a plurality of sensing wires disposed on the other of the substrate surface and the insulation layer along a second axial direction; and
a plurality of sensing units separately disposed on the other of the substrate surface and the insulation layer along the first axial direction;
wherein, each conductive wire is electrically connected to the corresponding sensing units through via holes.

11. The capacitive touch panel according to claim 10, wherein each conductive wire comprises:
a plurality of sub-conductive wires separately disposed;
wherein, adjacent two of the sensing units are electrically connected to the corresponding sub-conductive wire through two of the via holes.

12. The capacitive touch panel according to claim 10, wherein each conductive wire comprises:
two sub-conductive wires disposed on the one of the substrate surface and the insulation layer along the first axial direction.

13. The capacitive touch panel according to claim 12, wherein each conductive wire further comprises:
a cross conductive wire connecting the two sub-conductive wires.

14. The capacitive touch panel according to claim 10, wherein the insulation layer further comprises:
a plurality of conductive elements correspondingly disposed in the via holes;
wherein, the conductive wires are disposed on the substrate surface, the sensing units and the sensing wires are disposed on the insulation layer, and the sensing units, the sensing wires and the conductive elements are made from the same material.

15. The capacitive touch panel according to claim 10, wherein the insulation layer further comprises:
a plurality of conductive elements correspondingly disposed in the via holes;
wherein, the conductive wires are disposed on the insulation layer, the sensing units and the sensing wires are disposed on the substrate surface, and the conductive elements and conductive wires are made from the same material.

16. The capacitive touch panel according to claim 10, further comprising:
an optical film disposed on the insulation layer and covering the second sensing wires and the fourth sensing units.

17. The capacitive touch panel according to claim 16, wherein the refractive index of the optical film is smaller than 1.7.

18. The capacitive touch panel according to claim 17, wherein the optical film is made from silicon oxide, magnesium fluoride, aluminum oxide or yttrium oxide.
